(19) United States
(12) Patent Application Publication
(10) Pub. No.: US 2008/0086459 A1
(43) Pub. Date: Apr. 10, 2008

(54) INFORMATION PUBLICATION SYSTEM, METHOD AND APPARATUS

(75) Inventor: Grant James Ryan, Christchurch (NZ)

Correspondence Address: KNOBBE MARTENS OLSON & BEAR LLP, 2040 MAIN STREET, FOURTEENTH FLOOR, IRVINE, CA, 92614, US

(73) Assignee: Eurekster, Inc., San Francisco, CA (US)

(21) Appl. No.: 11/860,452

(22) Filed: Sep. 24, 2007

(30) Foreign Application Priority Data
Sep. 25, 2006 (NZ) 550140

(51) Int. Cl. G06F 7/00

(52) U.S. Cl. 707/3

(57) ABSTRACT

The invention relates to a set of computer executable instructions stored on a computer readable medium which are configured to implement a method of publishing information formatted for presentation using internet protocols. The instructions provided are configured to execute an initial step of delivering to a content author at least one indication of content of interest. These instructions then allow for the reception of at least one reference to an answer posting made by a content author and then the indexing of the at least one received reference into a search process to be completed by a search engine.

### TECHNICAL FIELD

This invention relates to an information publication system, method and apparatus. In particular the present invention may be used in conjunction with internet or web page posts of information to improve the chances of a searching person finding and retrieving specific information. Furthermore, the present invention may also be adapted to allow authors of web or internet formatted information to classify their creations, and also potentially to suggest new content to be published by such authors.

### BACKGROUND ART

The internet has become a powerful tool for publishing information. Internet search engines can crawl over content formatted as web pages to index same and allow users to search for information of interest.

Internet wide focused search engines have a good rate of success (estimated at approximately 60%-85%) when retrieving information using keywords specific to the content or focus of the information required. Internet wide search engines can however be problematic in operation where the keywords used have applicability over a range of disciplines. In such cases a set of keywords can return a large set of results listings which must be subsequently examined and filtered.

One attempt to alleviate this issue has been through the development of vertical or community based search engines. Such search engines are specifically tailored to provide results of the interest related to a particular topic or community of users. Users searching for material related to the specific topic of a vertical search engine are more likely to find relevant results quickly than with a general or internet wide search engine. However, to date vertical search engines do require a degree of maintenance and input from creators, and in practice need to be manually customised on a one off basis to ensure the results they provide are relevant.

One more recent attempt to address these issues has been through the development and release of the Swicki, being a search wiki (wikis generally being known as a collaborative information resource compiled by a community of interested users).

These search wikis or Swickis and their functionality are also generally described in PCT Patent Publication Nos. WO2006/011819, WO2005/029362 and WO2006/083181, U.S. Pat. No. 6,421,675 and New Zealand Patent Application No. 548606.

A Swicki is a new kind of search engine that allows anyone to create focused searches on topics of interest to a selected group of users. Unlike other search engines, the Swicki creator and contributors have control over the results provided, where the Swicki uses the wisdom of the relevant community to improve search results.

The Swicki publisher or creator can customise the search engine by adding keywords specifying websites that have content relevant or irrelevant to the topic of the search engine. For instance, a gaming site may include other gaming website URLs as important, and the Swicki will put results from those sites on the top of results lists. A publisher can also block results from certain blogs or websites, as detailed in the patent filings referenced above.

Such vertical style search engines may have improved usability but may not necessarily be able to find content which has yet to be formatted within a web page and posted to the internet.

The applicants have observed that in general, keywords entered into the search text box of a search engine primarily pertain to a question which a searching user wishes to have answered. The user will review the content of the search results returned to attempt to find the information required to answer their question. Presently, search engine technology focuses on indexing internet content in relation to its relevance to particular keywords. There is no direct focus placed on trying to answer the questions of searching users, nor is any attention paid to the performance of the search engine in retrieving information to solve such questions.

One attempt to improve the coverage of internet based information resources has been provided through question and answer (Q and A) services. These web page interface based systems allow a user to enter a natural language question which is subsequently distributed to a community of experts or persons experienced in the field of the question. After a fixed time period the answers submitted by these expert persons are posted to a web page of the service, which also provides a facility for other members of the interested community to rank or grade the quality of the answer given.

Such Q and A services do provide the ability for internet coverage gaps to be filled by interested contributors. However, to have their question answered, users must actively submit same and then wait through a submission period prior to answers becoming available. Furthermore the quality of answers submitted by designated experts in the field is only as reliable as the vetting applied in the selection of the expert group. Potentially, better quality or more accurate answers may be available from other persons who are not enrolled as contributing experts to such Q and A services.

It would therefore be of advantage to have an improved information publication and retrieval system and/or method which addressed any or all of the above problems. In particular, it would be of advantage to have an information search methodology which simply required a search engine keyword submission from a user to automatically prompt a community of interested persons into submitting new material not already available or retrieved by a search process. Furthermore a search engine facility which could determine that a user's initial search did not produce relevant results and which could subsequently solicit the submission of the required relevant information would be of advantage.

Existing internet wide search engines also normally rely on proprietary algorithms to attempt to retrieve relevant results and to order these results into a hierarchy of potential relevance. However, as discussed above such keywords can be used in a variety of fields and can have a range of meanings. It is therefore possible for results which are highly relevant to a user's search to receive a relatively low page rank in the results presented. It would therefore be of advantage to have an improved information indexing system, method or apparatus which allowed an author of such internet formatted information to designate or indicate particular topics to which such information is relevant. Furthermore it would also be of advantage to allow an author of such information to indicate which of a number of vertical search engines focused on specific topics of interest could potentially find the information presented relevant.

One popular internet based publication method utilises blog or web log software publishing tools, Blogs allow an author to periodically post text or other multi-media to a web page on demand, and also allow interested persons to submit comments in relation to the original posting. Blogs have become popular in recent years to give authors a wide audience for the content they wish to generate and to allow authors to receive feedback from the public interested in their offerings.

However, currently blog authors do not have any obvious mechanisms or techniques available to guide what content they should blog about. Authors can, after posting, receive feedback from their interested public regarding their content to improve any future postings. However, authors do not currently have an initial source of guidance available as to what content their public would be most interested in.

Content posted to the internet through blog technology does extend the coverage afforded by search engines which crawl or index such blog postings. However, the contribution of such blogs to the content available is effectively random or dependent on the whims and assumptions of blog authors. Information which can be made available from search engines regarding searches run by the reading public is presently not available to blog authors to drive the direction and focus of blog posts.

It would therefore be of advantage to have an improved information publication system, method and apparatus which addressed any or all of the above problems. In particular a system, method or apparatus which could assist in driving the selection of content which authors submit blog postings in relation to would be of advantage. Furthermore developments which promoted a particular community of users' awareness of their ability to improve offerings of content made over the internet, and which directly coupled search engine and blog technology to facilitate same would be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### SUMMARY OF CERTAIN INVENTIVE ASPECTS

According to one aspect of the present invention there is provided a set of computer executable instructions configured to implement a method of publishing information formatted for presentation using internet protocols, the instructions being configured to execute the steps of;
i) delivering to a content author at least one indication of content of interest, and
ii) receiving at least one reference to an answer posting made by a content author, and
iii) indexing the at least one received reference into a search process to be executed by a search engine.

According to another aspect of the present invention there is provided a set of computer executable instructions configured to implement a method of publishing information formatted for presentation using internet protocols, the instructions being configured to execute the steps of;
i) receiving a search query submitted by a user to a search engine, and
ii) presenting a search results listing provided by a search process of the search engine acting on the received search query, and
iii) detecting the search results listings failure to meet at least one requirement of the user, and
iv) distributing a user query to a plurality of content authors, and
v) receiving at least one reference to an answer posting made by a content author, and
vi) indexing the at least one received reference into the search process to be executed the search engine.

According to a further aspect of the present invention there is provided a method of publishing information, the information being formatted for presentation using internet protocols, the method being characterised by the steps of;
i) delivering to a content author at least one indication of content of interest, and
ii) receiving at least one reference to an answer posting made by a content author, and
iii) indexing the at least one received reference into a search process to be executed by a search engine.

In a further embodiment indications of content of interest are generated through search engine activities.

According to a further aspect of the present invention there is provided a method of publishing information, the information being formatted for presentation using internet protocols, the method being characterised by the steps of;
i) receiving a search query submitted by a user to a search engine, and
ii) presenting a search results listing provided by a search process of the search engine acting on the received search query, and
iii) detecting the search results listings failure to meet at least one requirement of the user, and
iv) distributing a user query to a plurality of content authors, and
v) receiving at least one reference to an answer posting made by a content author, and
vi) indexing the at least one received reference into the search process to be executed the search engine.

According to yet another aspect of the present invention there is provided a method substantially as described above wherein each answer posting made by a content author is presented in combination with a reputation factor associated with the content author.

According to yet another aspect of the present invention there is provided a method substantially as described above wherein an answer posting is configured to receive and present information not submitted by the original author of the answer posting.

Another aspect of the present invention is adapted to provide an information publication system, method and apparatus. Generally throughout this specification the present invention will be described in terms of a method or a methodology to be executed. However those skilled in the art should appreciate that suitable apparatus such as a computer system or computer systems programmed with executable instructions may provide such an associated apparatus or system, and references to a methodology in isolation throughout this specification should in no way be seen as limiting. In particular those skilled in the art should appreciate that the present invention may be implemented through computer executable instructions run in conjunction with the provision of a search engine facility.

Reference throughout this specification will be made to the present invention also being employed to publish information. Those skilled in the art should appreciate that a number of different facets or aspects of the present invention are explored throughout this specification, both in terms of use of the invention to search for particular information, and by authors being guided as to information which can be published. The term “published” throughout this specification should be taken to be understood as the release of information in a format which can be readily distributed to a range of persons or organisations. Those skilled in the art should appreciate that references to publishing of information may constitute the posting of content on a computer server which allows such content to be downloaded by interested persons or groups in one embodiment.

Those skilled in the art should appreciate that a range of implementations and applications for the present invention are envisioned in the area of publishing information content through internet technology. In particular, the present invention may be generally the to consist of techniques focused on soliciting the publication of new content from authors based on feedback from search engine technology, and the provision of guidance to content authors related to information to be published.

Reference in general throughout this specification will also be made to the present invention being employed to detect a search results listing failure and to subsequently solicit answer postings from content authors to remedy such a failure. However, those skilled in the art should also appreciate that the present invention may also be used outside of the detection of a search results listing failure as should be appreciated by those skilled in the art and as described further throughout this specification.

In one embodiment the present invention is adapted to publish information which has been formatted for presentation using internet protocols. This information may be formatted as web or internet pages which can include text and other forms of multimedia content. The present invention may be used to drive the publication of newly created content and allow search engines to readily present such new content as a search result if relevant to the current query of a searching user.

In such embodiments the methodology of the present invention may be initially instigated through a user submitting a search query to a search engine. Such a search engine may review the information it is aware of and has previously indexed into its search process to present to a searching user a search results listing. Those skilled in the art should appreciate that well known internet search engine technology may be employed to provide such a search engine facility in conjunction with the present invention.

In one embodiment the present invention may be configured to work with or may be integrated within the operation of a vertical search engine. Vertical search engines provide targeted search results listings which have a bias towards providing a high rank to search results which deal with a specific focus or topic. In general terms vertical search engines are more likely to have an associated community of interested persons or users who have experience in the field of interest and who frequently make use of the vertical search engine functionality.

Reference throughout this specification will also be made to the search engine involved being a Swicki vertical search engine. Swickis are a comparatively new development in the field of vertical search engines and allow the Swicki creator and its associated community of users a significant degree of control of the behaviour of the Swicki search process executed. Furthermore, the functionality of the Swickis described in the applicants earlier patent filings (such as for example, determining reputation of those involved with the Swicki) may also be employed in conjunction with the content solicited and/or published in conjunction with the present invention.

Such a search engine may solicit and receive a search query from a user and subsequently perform a search process to present to a user a search results listing.

The present invention may be configured or adapted to detect a search results listings failure to meet at least one requirement of a searching user. In general terms such user requirements may pertain to the relevance or utility of the information associated with each of the search results listings. Primarily such a determination may be made to assess whether any of the results presented to a user effectively satisfy or supply the information which the user was originally searching for.

However, in an alternative embodiment the failure of such search results to meet a range of user requirements may also be detected in conjunction with the present invention. For example, the presence of information authored by selected persons or groups, the formatting, language or reading comprehension level of such information or any other appropriate characteristic may all form a requirement of the user which should be met by at least one of the results presented to them. Furthermore in other embodiments the information required may be present in the search results, but may not necessarily be in an appropriate format or formatted effectively. In such instances information sought may be present but may not necessarily be readily usable and hence can trigger a failure of the search results.

In one embodiment the failure of the search results listing may be detected through a specific action of the searching user. For example, in one embodiment a web page interface for the Swicki search engine may include a button, check box or other appropriate input facility to allow a user to actively indicate that at least one of their requirements have not been met. In such instances a user may, for example, click on a “not answered” button to provide the failure detection required in accordance with the present invention.

However in other embodiments such failure detection may be passive in nature. For example, in one alternative instance, a failure detection may be made if a user does not click on or visit any of the search results presented within the search results listing. Furthermore, other mechanisms such as time out measurements or timing of the view duration of each results page may alternatively form passive mechanisms to detect that a user's requirements have not been adequately addressed.

Reference throughout this specification will be made to the provision of a user clickable button presented on a web page interface of the search engine to implement the detection of a search results listing failure. However, those skilled in the art should appreciate that other components or techniques may be employed to detect the failure of search results listings and reference to the provision of a user operable button only throughout this specification should in no way be seen as limiting.

Once a failure has been detected a user query may be distributed to a plurality of content authors. Such a user query may be formatted in a range of ways depending on the particular application the present invention. For example, in one embodiment the user query may have the same text or construction as the set of keywords submitted as the original search query presented by a user. However in other embodiments a user query may have additional information appended (such as the failed search results listing) or alternatively may have linking or non-distinguishing keywords removed from the original search query presented.

In one embodiment a content author to which a user query is distributed may be a person or a group associated with the Swicki search engine involved. Such content authors can generally be assumed to have experience or an interest in the particular topic or focus of the Swicki and hence may have the ability to generate content which satisfies the original searching user's requirements.

For example, in a further embodiment user queries may be distributed to all registered users of a Swicki search engine to advise such persons that the Swicki failed to meet the requirement of the current searching user. These communications can indicate that there is the potential for these persons to generate new content or information for subsequent publication or promotion by their Swicki.

However, in alternative embodiments new information or content may be solicited from content authors who are not directly registered or associated with the Swicki search engine. For example, in such embodiments such user queries may be distributed via public channels to solicit new information or content from as wider range of sources as possible.

In one embodiment a user query may be distributed via a real time communications channel or interface to provide notification to the content authors involved that their Swicki search engine has failed to provide the required results. Such real time channels may include RSS (really simple syndication) feeds, or alternatively instant messaging channels. Alternatively email transmissions of user queries may be made or user queries may be posted to a web page for viewing by either authorised content authors or the general public at large.

The distribution of a user query may in turn prompt at least one of the receiving content authors to generate new content which meets the searching user's requirements. Such new content may be integrated into an answer posting which again is formatted for display using internet protocols.

Such answer postings may be hosted by or using the same equipment, infrastructure and communication channels employed to implement the Swicki search engine involved. Such answer postings may be hosted in combination with the Swicki as they may potentially answer or provide information which is not currently available through the internet pertaining to the area of interest or focus of the Swicki.

An answer posting may include or consist of text in addition to potentially any other appropriate forms of multimedia. The information or content present within an answer posting may be formulated to effectively satisfy the original searching user's requirements.

In one embodiment an answer posting may also include an additional submission facility which is configured to receive and present information not submitted by the original or starting author of the answer posting. Such a facility may be used to gather and also publish comments by others associated with or interested in the Swicki pertinent to the content presented by the original author. Such further comments may be formatted in a similar style to that provided by blog or web log authoring tools. A single content author may present an answer or new material pertinent to the user query distributed, where the implementation of the answer posting also allows others within the community to comment on the quality of the original author's response.

In one embodiment an answer posting may also include advertising material or content which may be integrated into same automatically. Such advertising material may create a revenue stream for the creator and/or community of users associated with the Swicki, and furthermore may also be used to promote the submission of answers from content authors. In such instances revenue generated through the posting of advertising in answer postings may at least in part be directed to the original author of the answer posting.

Those skilled in the art should appreciate that a number of techniques may be employed to automatically select and integrate appropriate advertising or material into an answer posting. For example, the applicants pending U.S. patent application Ser. No. 10/213,017 provides details as to one potential method which may be used to implement such advertising content automatically.

In one embodiment an answer posting may include, present or be associated with a reputation factor for the original author of the answer posting. Such a reputation factor may in general indicate the possible quality or utility of the answer posting, potentially through a historical assessment of the quality of previous submissions or the behaviour of the posting author.

In a further embodiment a reputation factor may be associated or presented with an answer posting where the calculation and use of such a reputation factor is disclosed in the applicant's co-pending PCT Patent Application No. PCT/NZ2007/000188. Such reputation factors may be calculated in conjunction with Swicki search engine technology to allow the contributions of multiple persons to be sorted or ranked in terms of reputation or quality. As employed in conjunction with the present invention such reputation factors may be used to sort or assess the quality of answer postings produced by particular content authors. The mechanisms employed to formulate such reputation factors may allow the remaining community of persons interested in Swicki to vet via proxy the answer postings made by individual content authors.

In one embodiment the present invention may also facilitate the distribution of answer posting notifications. Such notifications may be distributed to any or all interested parties, from an original searching user through to the Swicki creator and also members of the associated Swicki community. In some instances such notifications may be implemented through emails, RSS feeds or instant messaging (for example) to provide real time notifications of the posting of a particular answer to a user's failed Swicki search. Such notifications may also allow the community associated with the Swicki to comment on and consider the new material posted by the original author of an answer posting.

One embodiment of the present invention is configured to receive at least one reference to an answer posting made by a content author. However, it is envisioned that the methodology employed may be able to receive a plurality of references to a number of answer postings made by a number of original content authors. Such references may consist of or incorporate address information which may be employed to retrieve the content of an answer posting. However, in other embodiments such references may also integrate or encapsulate the actual content of an answer posting if required.

One embodiment of the present may invention may on receipt of a reference to an answer posting index this received reference into the search process to be executed in accordance with the search engine. Those skilled in the art should appreciate that existing well known page crawling and indexing techniques may be employed to facilitate this process of the present invention. The reference, address or URL supplied may be recorded by the search engine employed in conjunction with categorising content tags, keywords or other relevant metadata to allow an answer posting to be served in future as a potentially relevant search result.

In one embodiment an answer posting may also have associated with it various forms or formats of metadata. As discussed above, a reputation factor for the original content author may be associated with an answer posting. Furthermore in other instances metadata such as keywords, subject matter, or topic indicators may be associated with an answer posting.

In some embodiments an answer posting may be created by a content author without the previous failure of a set of search results. In such instances content authors may independently decide to create and post such content, without necessarily being directly in response to the receipt of a user query. In such embodiments a content author may receive an indication of content of interest from a community or group of users, where this indication can guide the drafting and preparation of content to be presented by an author in a future answer posting. Such guided answer postings may in turn be indexed to a search process of a Swicki search engine or any other relevant search engines.

In such embodiments content authors may receive or have access to indications of content or interest. Such indications may be sourced from or prepared in conjunction with investigating search engine activity. A vertical search engine may provide data to indicate what content of interest a content author could potentially publish. Such search engine activities may for example list keywords, topics or subject matter identifiers relating to previous searches run by a community of interested users, through to indications of the potential failure of search results listings to meet the requirements of users.

In a further embodiment such answer posts may also include metadata pertaining to the identification of one or more Swicki search engines which deal with the topic or focus of the answer posting. Such Swicki identification metadata may be used to submit a reference to the answer posting to each identified Swicki to allow the identified Swickis to index the answer posting into their own search process.

In other embodiments such answers postings may also be linked to a content authors own blog or web log. A content author may independently author a blog post which they feel could effectively function as an answer posting for one or more Swickis, or alternatively a content author may nominate a particular answer posting for integration within their own independent blog if required.

The present invention may provide many advantages over prior art.

The present invention may provide guidance or feedback to content authors pertinent to content which a community of users wishes to access. Search engine activities may be employed to generate such indications of content to provide guidance to authors.

The applicants have identified that users employing search engines to enter keywords are normally looking to have a question answered. The present invention implements a new focus for search engine technology to allow the behaviour of users employing search engines to drive content authoring. The use of the present invention can assist in improving the quality and pertinence of results returned to users who wish to have their questions answered.

The present invention can also allow for the expansion of information coverage provided by a search engine and in particular a Swicki vertical search engine. The present invention may be configured to automatically solicit the generation of additional content which is not present or found by an initial search process and to subsequently index this new content so that it will be found by future search processes.

The use of the present invention can also improve the overall quality of search results returned. Through identifying the interest of users in a particular question, a focused and pertinent answer posting may be authored. In general terms this gives better search results even if the information content required to answer the question is already available in existing internet sources

The present invention also allows for the publication of blog style answer postings which have a much longer useful lifespan than standard blog postings. Generally speaking standard blog postings may provide information pertinent to users questions but are not normally retained or published as the current content of a blog as time progresses. The value of content published through blogs will erode over time as the information published becomes less accessible to searching users. Conversely, the present invention combines both the advantages of blogs and their ability to solicit feedback from others, in addition to directly publishing the information involved in a long term facility for access by searching users.

The present invention may also provide a facility for content authors to publish information without any future obligations to maintain the currency of such publications or to commit to any future publications. The present invention can allow interested persons to contribute a publication through an answer posting without necessarily committing the author to any further postings, which is not the case with website or blog publication formats. This in turn lowers barriers to involvement by potential authors, giving the ability to provide access to more content which may not necessarily have been published.

The present invention may provide access to the accumulated knowledge and experience of a large community of content authors without necessarily the same restrictions on author membership and answer submission time frames employed by existing Q and A services. Furthermore, any answer postings submitted by a content author may also have displayed a reputation factor for the author involved, and also commentary and feedback from other users within the community associated with a particular Swicki. The use of the present invention with a Swicki also automatically puts any entered set of search keywords into a particular context of use. In such applications both quality search results and also pertinent answer postings may be provided relatively easily.

The present invention may also allow content authors to readily associate pertinent metadata with answer postings which indicate the topic or area of interest for a particular answer posting and specifically the identities of one or more Swicki search engines which the content of the answer posting relates to. The present invention may also provide such functionality in cases where the failure of an initial search process has not been detected or determined, and in which a content author wishes to publish certain content in an answer posting format.

### BRIEF DESCRIPTION OF THE DRAWINGS

Further aspects of the present invention will become apparent from the following description which is given by way of example only and with reference to the accompanying drawings in which:

FIG. 1 shows a block schematic diagram of an information indexing process provided in accordance with one embodiment of the present invention.

FIG. 2 shows an example screenshot of a Swicki vertical search engine results listing provided in accordance with one embodiment, and

FIG. 3 shows an example screenshot of a Swicki vertical search engine results listing provided in accordance with an alternative embodiment, and

FIG. 4 illustrates the provision of an answer posting provided in accordance with one embodiment, and

FIG. 5 illustrates indications of content of interest which authors can provide answer postings in relation to.

### DETAILED DESCRIPTION OF CERTAIN INVENTIVE EMBODIMENTS

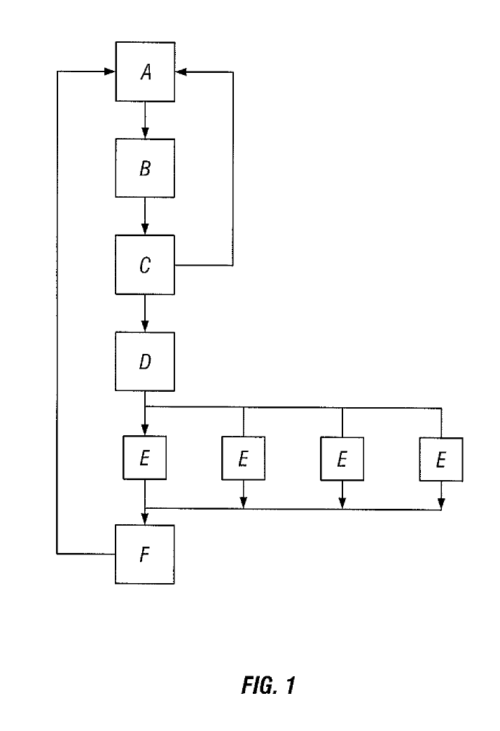

FIG. 1 shows a block schematic diagram of an information indexing process provided in accordance with one embodiment of the present invention. In the implementation discussed below a vertical search engine is formed by a Swicki focused on the topic of ball bearings.

At the first stage A of this process a Swicki vertical search engine receives a search query in the form of a number of keywords. In the example under investigation an interested user in this case enters a search term “durability calculator”.

Next, at stage B, a set of search results from the Swicki is presented to a searching user after a search process is completed.

At stage C a detection or determination is made as to whether the searching user's requirements have been met. In one embodiment a requirement to be satisfied is the presence of specific information answering a question. If this requirement is met the process illustrated returns to the search engine to awaiting the receipt of further search queries at stage A.

In the example at hand the searching user did not click on any of the results presented, and clicked on a user interface button requesting help on their search query.

As the required information is not present within the search results listing, stage D of this process is executed. At stage D a reformatted user query is distributed to a group of content authors. In one embodiment, these content authors are registered users of the Swicki search engine involved. In this example content authors are notified that an unanswered question has been submitted with respect to the term “durability calculator”.

At stage E four independent content authors are shown as having responded to the user query distributed by creating an answer posting and by supplying back to the Swicki search engine a reference to the URL or address of each of the postings made. Each posting may be made in a blog format allowing others in the Swicki community to comment on the quality or utility of the original content author's contribution.

In the current example four content authors generate an answer posting discussing ball bearing durability calculations. The posting of each author can include links to other resources as well as providing the facility for other interested users to submit comments with respect to the posting.

These postings may also be linked to or directly integrated into the author's personal blog. In such instances the author's personal blog may display a reputation indicator which is associated with one or more Swickis. Such a reputation indicator can be applied as a reference to the perceived quality of that author's work. The submission of an answer posting may also be employed to promote or modify the reputation factor associated with the generating content author.

Each answer post can be include metadata to indicate that the posting made can be submitted to other Swickis such as mechanical engineering focused or mechanical friction focused Swickis.

In addition, such answer postings may also have advertising content automatically integrated into their format. In the example at hand, an advertisement may be automatically placed for ‘Ball Bearing Consultants Limited’, providing the ability for a content author to receive a revenue stream based on their efforts.

Once the answer posting is effectively published the original searching user is notified of the publication of new content through an RSS feed, email, instant messaging or any other suitable notification technique. Other members of the Swicki community involved are also alerted to the fact that an answer posting has been submitted and that hey can provide comments directly themselves into each answer posting.

Finally at stage F each of the referenced URL addresses of the answer postings prepared are indexed into the search process to be completed by the Swicki search engine. This indexing process allows each of the answer postings created to be listed as a future search result in a search results listing.

Finally once the answer postings are indexed, the Swicki search engine returns to awaiting the receipt of a search query at stage A of this process.

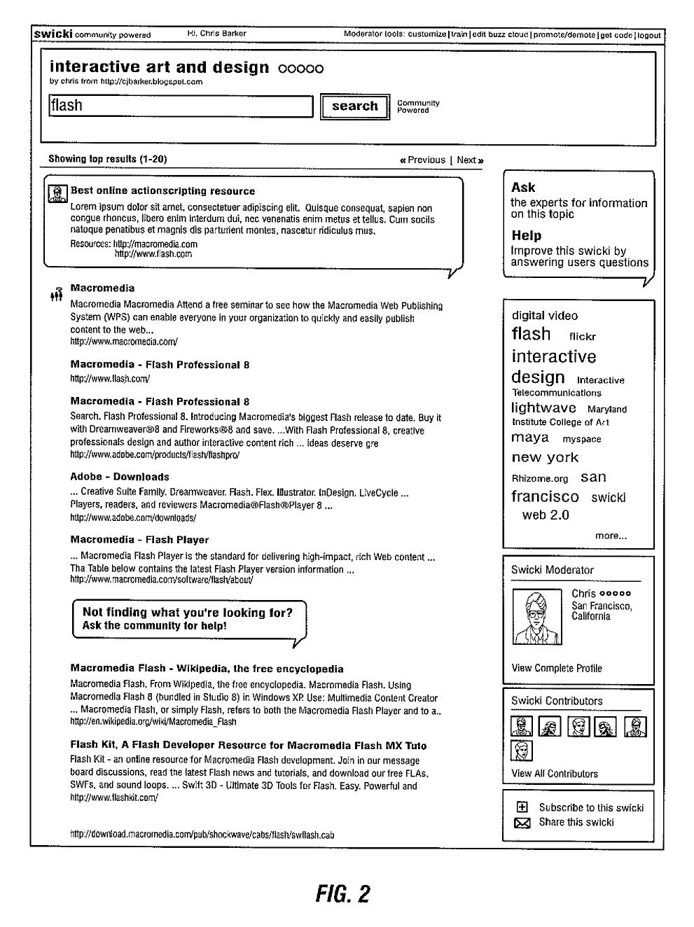

FIG. 2 shows an example screenshot of a Swicki vertical search engine results listing provided in accordance with one embodiment.

As can be seen from FIG. 2 a series of search results are provided in relation to the search term “flash”. The Swicki search engine involved is particularly focused on topics relating to interactive art and design. On the right hand side of the panel a “buzz cloud” of suggested keywords is illustrated, as are details of the Swickis moderator and details of a select set of contributors to this Swicki.

FIG. 2 illustrates the end result provided by the present invention in the form of a link to an answer posting. This answer posting is provided as the first result listed in terms of the flash keyword search. This search result is identified as an answer posting through the speech bubble surrounding same, in addition to the photograph provided of the content author of the answer posting.

Also illustrated in the right hand side panel are an “ask” link and a “help” link. Clicking on the ask link allows the searching user to explicitly indicate that the search results presented have not answered their query. A click through on this link will then result in the distribution of a user query to a number of content authors as described above.

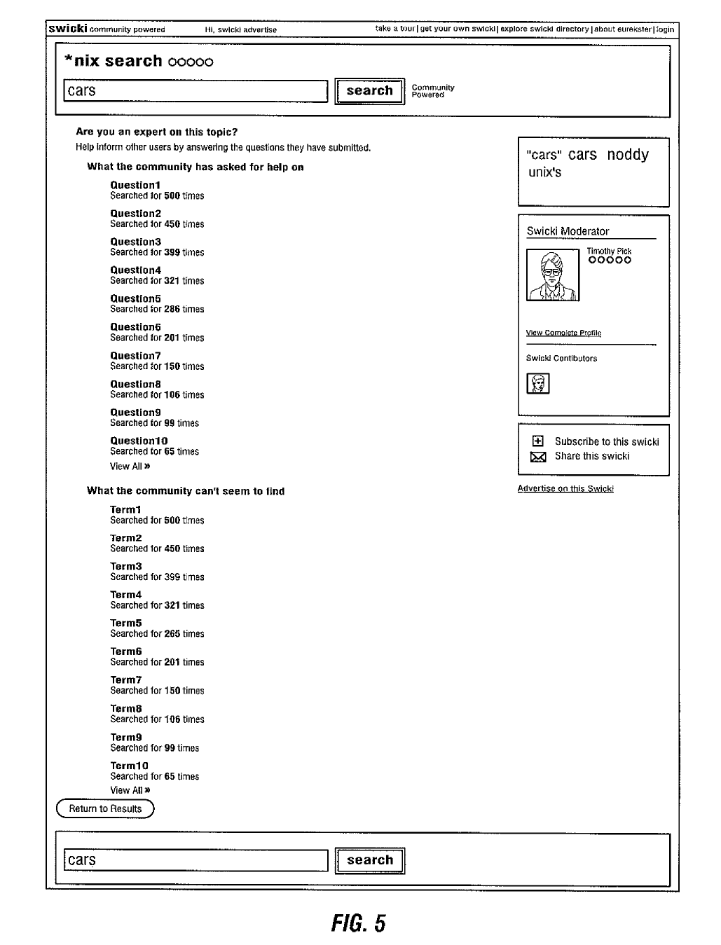

A click made on the help link allows the searching user to help improve the performance of the Swicki search engine by answering other users' questions. Clicking on the help link will take the user involved to the interface screen shown and discussed with respect to FIG. 5.

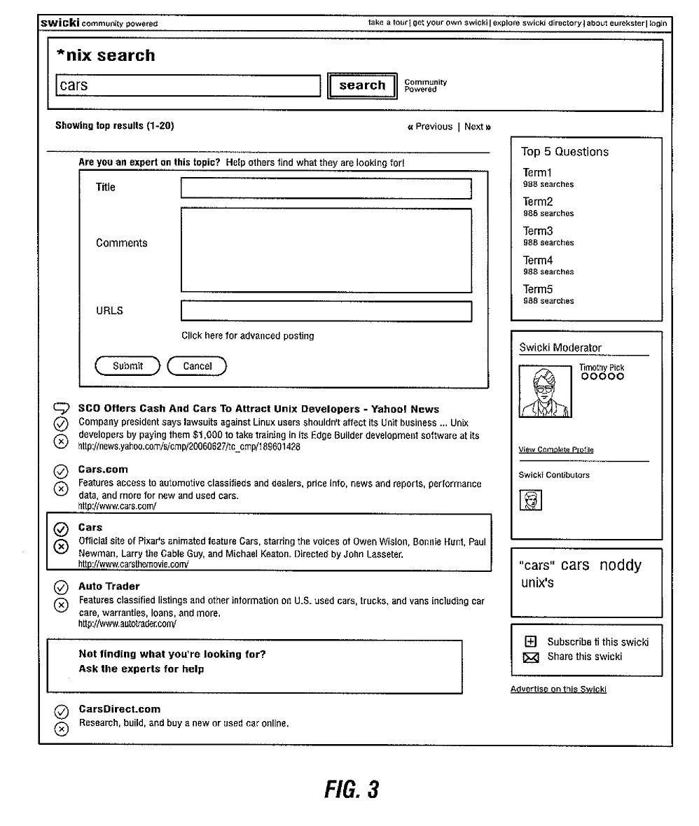

FIG. 3 shows an example screenshot of a Swicki vertical search engine results listing provided in accordance with an alternative embodiment.

With respect to FIG. 3 a set of search results are again provided, with the speech bubble shown on the left hand side of the first result indicating this search result is a link to an answer posting. The other icons shown with respect to each result allow users to provide feedback as to the relevance or otherwise of a result.

Again on the right hand side of the panel are details of the Swicki moderator, as are details of contributors to the Swicki. The right hand side of the panel also illustrates the top five questions submitted in relation to the Swicki—which potentially could be the subject of future answer postings.

The page shown also includes a basic form based text entry system for an answer posting. A user may enter relevant content into these text boxes and have this answer posting both hosted by the Swicki and indexed into the search processes provided.

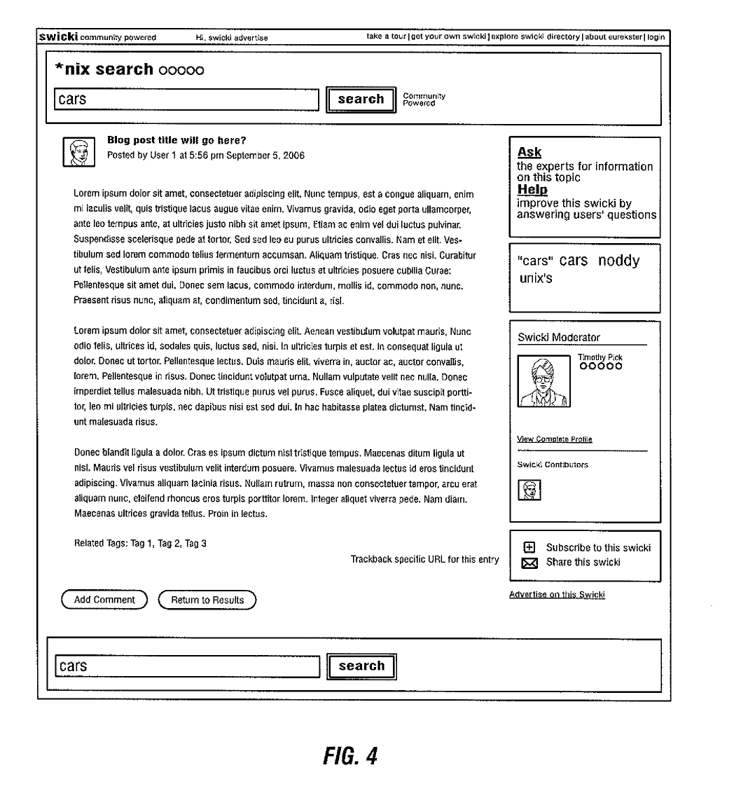

FIG. 4 illustrates the provision of an answer posting provided in accordance with one embodiment.

As can be seen from FIG. 4 an answer posting may start with a title in combination with a photograph or other similar icon identifying a particular content author. In the example shown, a text focused answer posting is provided as well as a number of content tags in relation to this answer text. The add comment button shown at the bottom of the posting allows other users to submit comments to the answer posting.

FIG. 5 illustrates indications of content of interest which authors can provide answer postings in relation to.

An initial set of questions is shown where individual searching users have clicked through on the help link shown with respect to FIG. 2. For each of the ten potential questions shown a count can be maintained with respect to the number of times that question has been submitted for the attention of the Swicki community.

A second set of indicators for content of interest are shown under a reference to what the community cannot seem to find. In these cases particular search terms or keywords are shown in combination with a count of the number of times a failure of the relevant search results has been detected. For example, in this instance a failure of the search results would be detected if the searching user does not click through on any of the results listed.

Aspects of the present invention have been described by way of example only and it should be appreciated that modifications and additions may be made thereto without departing from the scope thereof as defined in the appended claims.

What we claim is:

1. One or more processor-readable storage devices having processor-readable code, the processor-readable code for programming one or more processors to perform a method of publishing information formatted for presentation using internet protocols, the method comprising:
i) delivering to a content author at least one indication of content of interest;
ii) receiving at least one reference to an answer posting made by a content author; and
iii) indexing the at least one received reference into a search process to be executed by a search engine.

2. One or more processor-readable storage devices of claim 1, wherein an indication of content of interest is generated through search engine activities.

3. One or more processor-readable storage devices having processor-readable code, the processor-readable code for programming one or more processors to perform a method of publishing information formatted for presentation using internet protocols, the method comprising:
i) receiving a search query submitted by a user to a search engine;
ii) presenting a search results listing provided by a search process of the search engine acting on the received search query;
iii) detecting the search results listings failure to meet at least one requirement of the user;
iv) distributing a user query to a plurality of content authors;
v) receiving at least one reference to an answer posting made by a content author; and
vi) indexing the at least one received reference into the search process to be executed the search engine.

4. One or more processor-readable storage devices of claim 1, wherein a content author is a person or a group associated with the search engine.

5. One or more processor-readable storage devices of claim 1, where the search engine is a vertical search engine.

6. One or more processor-readable storage devices of claim 3, wherein failure of the search results listing is detected through an action of the searching user.

7. One or more processor-readable storage devices of claim 3, wherein a failure detection is made if a user does not visit any of the search results presented within the search results listing.

8. One or more processor-readable storage devices of claim 1, wherein an answer posting is formatted for display using internet protocols.

9. One or more processor-readable storage devices of claim 1, wherein an answer posting includes text and/or multimedia.

10. One or more processor-readable storage devices of claim 1, wherein an answer posting includes advertising material.

11. One or more processor-readable storage devices of claim 1, wherein an answer posting is configured to present information not submitted by the original author of the answer posting.

12. One or more processor-readable storage devices of claim 11, wherein an answer posting publishes comments made by others associated with or interested in the content presented by the original author.

13. One or more processor-readable storage devices of claim 1, wherein an answer posting made by a content author is presented in combination with a reputation factor associated with the content author.

14. One or more processor-readable storage devices of claim 13, wherein a reputation factor indicates the possible quality or utility of the answer posting.

15. One or more processor-readable storage devices of claim 3, wherein a user query includes the set of keywords submitted as the original search query presented by a user.

16. One or more processor-readable storage devices of claim 3, wherein a user query is distributed via a real time communications channel.

17. One or more processor-readable storage devices of claim 16, wherein a user query is distributed through email, RSS feed or instant message.

18. One or more processor-readable storage devices of claim 1, wherein an answer posting has metadata associated with it.

19. One or more processor-readable storage devices of claim 18, wherein metadata is formed from keywords, subject matter indications, or topic indicators.

20. One or more processor-readable storage devices of claim 18, wherein the metadata identifies at least one vertical search engine.

21. A method of publishing information formatted for presentation using internet protocols, the method comprising:
i) delivering to a content author at least one indication of content of interest;
ii) receiving at least one reference to an answer posting made by a content author; and
iii) indexing the at least one received reference into a search process to be executed by a search engine.

22. A method of publishing information formatted for presentation using internet protocols, the method comprising:
i) receiving a search query submitted by a user to a search engine;
ii) presenting a search results listing provided by a search process of the search engine acting on the received search query;
iii) detecting the search results listings failure to meet at least one requirement of the user;
iv) distributing a user query to a plurality of content authors;
v) receiving at least one reference to an answer posting made by a content author; and
vi) indexing the at least one received reference into the search process to be executed the search engine.

23. An apparatus for publishing information formatted for presentation using internet protocols, the apparatus comprising:
i) means for delivering to a content author at least one indication of content of interest;
ii) means for receiving at least one reference to an answer posting made by a content author; and
iii) means for indexing the at least one received reference into a search process to be executed by a search engine.
